(19) United States
(12) Patent Application Publication
(10) Pub. No.: US 2010/0150536 A1
(43) Pub. Date: Jun. 17, 2010

(54) Lighting system for audio visual recording booth

(76) Inventors: Lawrence G. Ryckman, Scottsdale, AZ (US); Richard Brown, Scottsdale, AZ (US)

Correspondence Address: TOD R NISSLE, PO BOX 55630, PHOENIX, AZ, 85078, US

(21) Appl. No.: 12/586,740

(22) Filed: Sep. 25, 2009

Related U.S. Application Data
(60) Provisional application No. 61/194,333, filed on Sep. 26, 2008.

(51) Int. Cl. G03B 15/00

(52) U.S. Cl. 396/2

(57) ABSTRACT

A system to make an audiovisual recording in a booth includes in the booth a camera mounted on the front wall, LED lighting mounted on the front wall, and a green screen extending over the back wall of the booth.

This application claims priority based on provisional application Ser. No. 61/194,333, filed Sep. 26, 2008.

We have discovered a new light system for a booth in which an individual can perform and make an audiovisual recording of the performance.

The interior of the booth includes a front wall, a back wall, and side wall extending between the front and back walls. When an individual is inside the booth, he faces the front wall and, consequently, faces a camera positioned in the central area of the front wall of the booth. The camera preferably can be adjusted up and down and has a zoom lens system.

Lighting on the front wall, i.e., on the camera wall, comprises banks of red, green, blue LEDs. Lights other than LEDs can be utilized, but LEDs are preferred. The LEDs produce light that emanates from the front wall toward the back wall. The number of LEDs can vary as desired, but currently there are eight horizontal banks or strips of LEDs on the front wall above the camera, and there are six vertical banks or strips of LEDs on the front wall on each side of the camera. The vertical strips generally extend all or a majority of the entire distance from the ceiling and the floor. There are also five banks or strips of LEDs on the back wall adjacent the ceiling of the booth. The strips of LEDs on the back wall are above the “green wall” that comprises the back wall of the booth.

The LED's are connected to a microprocessor control unit. The control unit can adjust the intensity of each LED, individually or bank by bank; and can turn off individually each LED or each bank. Accordingly, the intensity of light produced by the LEDs is adjusted by varying the intensity of each individual LED or of banks of LEDs when the LEDs are on, and by turning off LEDs individually or bank by bank, as desired.

Sets of three LED's are included in each bank of LEDs. Each set of three LEDs includes a red LED, a blue LED, and a green LED. The intensity of each LED in each such set of three LEDs can be adjusted such that the set of three LEDs can produce 5000 colors. In use of the recording booth, however, it would be unusual for all of the LEDs to be blue or red or green at the same time.

The recording booth could, but likely will not, have LEDs on the side walls, floor, or back walls (except on at or adjacent the top of the back wall).

When a customer steps into a recording booth, the back wall of the booth consists of a “green screen” and is, to the eyes of the customer, green (or some other desired color).

One green screen preferred in the practice of the invention is constructed as follows. Ceelite panels on the back wall of the recording booth back light a panel(s) of green gel or other green translucent material. A translucent, non-glare, protective plexiglass cover about one-quarter inch thick covers the green translucent material. The intensity of the light produced by the Ceelite panel can be varied. The Ceelite panel has a phosphorus material that is excited by a capacitor at periodic short intervals. The back light produced by and emanating from the back consequently has a very even intensity which is substantially equivalent at each point on the Ceelite/gel/plexiglass background. The outer surface of the plexiglass is presently preferably flat and smooth, but can be roughened up to produce a non glare surface that still appear to the camera to be very smooth.

The camera is operated and evaluated to find the proper color temperature to work with in conjunction with the camera. The camera focuses in on a piece of white material and that becomes the white reference.

The camera is operated and evaluated to see what light temperature worked best on people's faces in the booth and what light temperature worked best with respect to the back “green screen”. The color produced by the back wall need not be green, but can be blue or another desired color.

In the practice of the invention, red, blue, and green light are mixed to produce a key light in a recording booth.

Three kinds of lights ere key, fill, and back light. Key light provides the majority of the light intensity in a particular environment.

Back light is used to separate the subject (i.e., the performer in the booth) from the background. The back light in the booth can never comprise key light or fill light.

Fill and key light emanate from the front wall of the interior of the booth. If all light or the majority of light emanates from one side of the front wall, then one side of a performer's face can appear dark. The dark side of the performer's face can be filled with colored light or white light. Fill light generally has an intensity and/or wavelength different than the intensity and/or wavelength of key light.

Each bank of LEDs presently has twelve LEDs. When a customer is using the recording booth of the invention, at least four of the light banks on the front wall of lights will be on.

An LED can be dimmed by modulating the frequency of the light. LEDs permit the appearance of an individual to be adjusted without reducing the intensity of the LEDs, although the intensity can, if desired, be reduced.

Typically, about 400 watts of power in the booth is used by the LED lighting system.

With respect to the color balance of the booth digital camera, the camera is directed, or “shot”, at a white surface and a color balance reference point is determined using a color temperature meter. The camera goes through set up program that will reference the camera on the white; that is called a color balance reference. The camera can in its color balance reference point determination can go from 2000 degrees K to 8000 degrees K. In one embodiment of the invention, the proper setting for the camera in the booth was determined as follows: the initial setting evaluated was in the range of 3000 to 7000 degrees K, the next setting in the range of 400 to 6000 degrees K, then 4000 to 5200, then 5200 to 5600, and finally 5200 degrees K. 5200 degrees K was determined to be the best setting for the camera in conjunction with the green screen background on the back wall on the interior of the booth.

The 5200 K is a reference number that enables one to know how to achieve white on skin to get skin tones to have the desired appearance.

Since white comprises a combination of all colors, the camera goes through a internal program to balance colors so the camera knows what white looks like. This procedure is called white balancing and is done to adjust for the difference temperatures used for lighting. The goal is to obtain the best representation of a subject who is illuminated by the interior lighting of the booth.

A digital camera has three integrated chips, a red chip, blue chip and green chip. By having a green background you turn off the green chip so camera “sees” black and can substitute a selected background picture. Blue or green are usually used as a background because human skin has fewer blue and green pigments. But, a red background can be used.

With LEDs, it is possible, by balancing red, blue and green, to balance the green background light so that it is the same color temperature as the subject.

Brightness is intensity in foot candles. Color temperature has to do with how the frequency falls in the color spectrum.

When a performer is in the booth and selects a particular background, the microprocessor in the booth adjusts the lights in the booth to predefined settings that will be utilized with the background that will be substituted for the green screen. These predefined setting were arrived at when the particular background was earlier tested and the light settings for that particular background were predefined during such testing. Accordingly, when an individual step into a booth and selects that particular background, the microprocessor in the booth automatically adjusts the lights in the booth to the earlier determined predefined light settings.

In use, a particular digital background is selected, and light settings are selected for the background. The lights in a booth are set to the selected setting, the digital background is shown on the green screen, and a lab technician goes into the recording booth and evaluates the lighting. If necessary, the lighting settings are readjusted and the lab technician again goes into the recording booth and evaluates the lighting. If desired, the intensity of the lights can be adjusted, or the balance between red, blue, and green lights can be adjusted, or banks can be turned on and off. This process is repeated until the lighting set-up in the booth is acceptable and desirable. One reason the lighting set-up can be found desirable is that the lighting brings out a particular color(s) in the background. Another reason the lighting set-up can be desirable is that the lighting mimics the time of day: if the background comprises a picture of a location at night, the lighting set-up mimics night time lighting, or, if the background comprises a picture of what a location looks like at sunrise, the lighting set-up mimics sunrise lighting. Any other desired criteria can be utilized to determine that a lighting set-up for a particular background is desirable and acceptable. Once the lighting for a background is deemed acceptable, the light settings (white balance, intensity, number of green lights on vs. number of red and blue lights, number of lights off, etc.) are noted and fixed for that particular background. The fixed settings are recorded in the memory of the control microprocessor so that when a consumer utilizing the booth selects that particular background, the light settings for that background will automatically be utilized in the booth and will be ordered by the control microprocessor. The foregoing procedure is repeated for each different background so that each background has its own associated fixed light settings recorded in the memory of the control microprocessor, and when an individual in the recording booth selects a particular background, the microprocessor that is operating the booth calls up and utilizes the fixed associated light settings associated with that particular background to properly illuminate at a desired intensity selected lights in the booth.

In another embodiment of the invention, the light intensities produced by the LEDs are varied by the microprocessor control unit to correlate to the individual and a background that will be substituted for the green background viewed by the camera. The settings, including intensities, of the light banks may change during a consumer's performance in the booth because the background coloring/intensity may change. LED changes are correlated with changes in color and/or intensity in the background that will be substituted by a computer in place of the green background viewed by the camera when a consumer is performing in a recording booth and the camera is recording the performance. The intensity and other LED settings can also be adjusted to change the appearance of the individual to correlate, in any desired manner, the individual to the background. For example, if the background is orange, the LEDs can be adjusted to give the performance an orange glow.

In one embodiment of the invention, an individual can provide their own background. The background can, for example, be on a DVD that is read at the recording booth and is, after the individual performs, inserted by computer for the green background that is viewed by the booth camera when the individual is performing against the green background produced by the back wall of the recording booth. Or, a background desired by an individual can be downloaded to a web site and combined with the performance that is recorded when the individual is performing in the recording booth. As used herein, the recording booth normally is remote from the Internet web site utilized in conjunction with the recording booth.

The Internet web site can provide an individual the ability to edit, on-line at the web site from the individual's at home or business computer, a recording of the individual, including varying color intensities in the recording, inserting a laugh track, cut and paste, etc.

In one system utilized in conjunction with an audiovisual recording booth, EMI or another organization that licenses copyright agrees to be paid by the operator of the booth a one time license fee of $1.50 or some other agreed on value for a song used by a consumer who records a performance in the booth. The licensing fee enables the consumer to play and/or show the recording as many times as he or she wishes. In addition to the one time licensing fee EMI can be given a percentage of advertising sold for use at, on, or conjunction with the recording booth.

One particular advantage of having multiple recording booths at different locations is to record many people auditioning for a particular reality or other show. Reviewing such recording is a convenient way to have a “casting call” that can view many individuals in a relatively short period of time.

When a consumer utilizes and pays a fee to enter and use the recording booth to record a performance by the consumer, the booth prints a card with the consumer's name on the card. The card also has an alphanumeric privacy code and a bar code imprinted on the card. The card is good for 30 days or some other desired period of time. To start a recording session, the card is swiped inside the recording booth. The privacy code allows the consumer to see his or her recorded video by typing in the privacy code (or privacy code and other required information) on the computer keyboard when the recording is accessed at an Internet web site (the recording made in the booth is transmitted from the booth to an Internet accessible web site). The alphanumeric privacy code can be given by the consumer to other parties.

Having described our invention in such terms as to enable those of skilled in the art to understand and practice it, and having described the presently preferred embodiments and best mode thereof,

We claim:

1. A system to make an audiovisual recording in a booth, including in the booth a camera mounted on the front wall, LED lighting mounted on the front wall, and a green screen extending over the back wall of the booth.
